(19) United States
(12) Patent Application Publication
(10) Pub. No.: US 2025/0323993 A1
(43) Pub. Date: Oct. 16, 2025

(54) DISCREET EMERGENCY RESPONSE SYSTEM AND METHOD FOR MOBILE COMMUNICATION DEVICES

(71) Applicant: 3RD-I TECHNOLOGY INC., CHESTER, NJ (US)

(72) Inventor: Dillon Abend, Chester, NJ (US)

(21) Appl. No.: 19/177,266

(22) Filed: Apr. 11, 2025

Related U.S. Application Data
(60) Provisional application No. 63/632,568, filed on Apr. 11, 2024.

(51) Int. Cl. H04M 1/72424; H04M 1/72421; H04W 4/90

(52) U.S. Cl. CPC H04M 1/72424; H04M 1/72421; H04W 4/90

(57) ABSTRACT

A system and method for initiating a discreet emergency response for a user of a mobile communication device having front and rear facing cameras, a microphone and a GPS receiver, the method including providing an application on the device capable of receiving a session initiation input and, responsive to the session initiation input, activating a potential emergency session with a remote dispatcher or monitoring center. This includes transmitting an emergency data stream to be accessible to the remote dispatcher or monitoring center. The emergency data stream including a first video stream for video images from a front-facing camera, a second video stream from a rear-facing cameras an audio stream from a microphone, and a stream of geolocation coordinates from the GPS receiver.

### CROSS-REFERENCE TO RELATED APPLICATIONS

This application claims the benefit of U.S. Provisional Application No. 63/632,568 filed Apr. 11, 2024, the disclosure of which is hereby incorporated herein by reference in its entirety.

### FIELD OF THE INVENTION

The present invention relates to the field of mobile safety systems and emergency alert technologies. More particularly, it relates to systems and methods for discreetly initiating and maintaining real-time, multimedia emergency broadcasts via mobile communication devices, enabling passive activation, secure transmission, and dispatcher access in high-risk or constrained environments.

### BACKGROUND OF THE INVENTION

Despite the proliferation of personal safety applications, many still rely on overt actions by users—such as dialing emergency services or verbally requesting help. These methods may escalate threats or be impossible in rapidly unfolding emergencies. Moreover, current systems lack contextual real-time data, such as visual/audio feeds or precise location tracking, and few provide reliable ways to notify emergency responders without detection.

There is a substantial unmet need for a system that enables users to discreetly activate a comprehensive emergency response mechanism—one that integrates live dual-camera video, continuous location updates, audio feeds, autonomous threat detection, and secure cloud storage—without the need for vocalization, app unlocking, or visible interaction.

### SUMMARY OF THE INVENTION

The following presents a simplified summary of the disclosure in order to provide a basic understanding of some aspects of the various embodiments disclosed herein. This summary is not an extensive overview of every detail of every embodiment. It is intended to neither identify key or critical elements of every embodiment nor delineate the scope of every disclosed embodiment. Its sole purpose is to present some concepts of disclosure in a simplified form as a prelude to the more detailed description that is presented later.

The invention provides a software-based emergency broadcast system that may include hardware integration, designed to be discreetly activated through one or more input modalities, including voice-activated safe words, shake gestures, hardware button sequences, widgets, and Bluetooth peripherals. Once triggered, the system may initiate continuous livestreaming from both the front-facing and rear-facing cameras, record environmental audio, and/or transmit live GPS coordinates to a remote dispatcher or monitoring center.

In an embodiment, a method for initiating a discreet emergency response for a user of a mobile communication device having a front-facing camera, a rear-facing camera, a microphone, and a GPS receiver, where the method may include providing an application on the device capable of receiving a session initiation input. The method may further include, responsive to the session initiation input, activating a potential emergency session with a remote dispatcher or monitoring center, which may include transmitting an emergency data stream to be accessible to the remote dispatcher or monitoring center. The emergency data stream may include a first video stream for video images recorded by the front-facing camera of the mobile communication device, a second video stream for video images recorded by the rear-facing cameras of the mobile communication device, an audio stream recording of environment audio stream recorded by the microphone of the mobile communication device, and a stream of geolocation coordinates from the GPS receiver.

In an embodiment, a system for monitoring rider safety may include a monitoring system that may have an AI model trained to identify dangerous circumstances in video streams or audio streams, and a first client application installed on a user's mobile communication device. The first client application, upon activation of a first potential emergency session, may transmit a first emergency data stream to be accessible by the monitoring system. The first emergency data stream may include a front-facing camera video stream, a rear-facing camera video stream, an audio stream, and a geolocation data stream. The monitoring system, upon receiving an activation of a potential emergency session, may assign the potential emergency session to a first administrator, and provides the first administrator with access to the first emergency data stream.

### BRIEF DESCRIPTION OF THE DRAWINGS

The drawings set forth exemplary embodiments of the disclosed concepts and are not intended to be limiting in any way.

FIG. 1 illustrates a system architecture diagram for a safety system in accordance with the disclosed concepts.

FIG. 2 illustrates is a flow diagram of user input modalities and their respective activation triggers to initiate a potential emergency session.

FIG. 3 illustrates flow diagram for communication between the user and a remote dispatcher, for emergency escalation.

FIG. 4 is a flow diagram showing the broadcasting of the live streamed location information to viewers.

FIG. 5 illustrates a method for increasing a user's safety by providing an application allowing for the initiation of potential emergency sessions.

FIG. 6 illustrates a system diagram for a system for rider safety in accordance with the disclosed concepts.

FIG. 7 illustrates a user device that may be used with the systems and methods of FIGS. 1-6.

FIG. 8 illustrates a graphical user interface layout for a dashboard in accordance with the disclosed concepts.

### DETAILED DESCRIPTION OF THE INVENTION

The following detailed description and the appended drawings describe and illustrate exemplary embodiments solely for the purpose of enabling one of ordinary skill in the relevant art to make and use the invention. As such, the detailed description and illustration of these embodiments are purely exemplary in nature and are in no way intended to limit the scope of the invention, or its protection, in any manner. It should also be understood that the drawings are not to scale and in certain instances details have been omitted, which are not necessary for an understanding of the present invention, such as conventional details of fabrication and assembly.

In an embodiment, a method for initiating a discreet emergency response for a user of a mobile communication device having a front-facing camera, a rear-facing camera, a microphone, and a GPS receiver, where the method may include: providing an application on the device capable of receiving a session initiation input. The method may further include, responsive to the session initiation input, activating a potential emergency session with a remote dispatcher or monitoring center, which may include transmitting an emergency data stream to be accessible to the remote dispatcher or monitoring center. The emergency data stream may include a first video stream for video images recorded by the front-facing camera of the mobile communication device, a second video stream for video images recorded by the rear-facing cameras of the mobile communication device, an audio stream recording of environment audio stream recorded by the microphone of the mobile communication device, and a stream of geolocation coordinates from the GPS receiver.

In certain embodiments, the method may further include displaying the application in picture-in-picture mode on the mobile communication device. In certain embodiments, the activating the potential emergency session may further include enabling two-way messaging with the remote dispatcher or monitoring center. In certain embodiments, the method may further include maintaining the activated potential emergency session until a secure PIN is entered to terminate the potential emergency session.

In certain embodiments, the session initiating input may be selected from the following group: a widget tap, a safe word, a motion gesture, a hardware button sequence, a software button sequence, and a peripheral device. In certain embodiments, the method may further include initiating an emergency response request to request assistance from local authorities. In certain such embodiments, the method may further include automatically initiating the emergency response request responsive to AI-based detection of visual threat cues detected from the first video stream or the second video stream. In certain such embodiments, the method may further include automatically initiating the emergency response request responsive to AI-based detection of visual threat cues detected from the audio stream. In certain embodiments, the method may further include transmitting a high-priority sound notification using a mobile device's critical alert entitlement framework to designated emergency contacts responsive to the initiating an emergency response request, wherein the alert bypasses device mute and do-not-disturb states and includes a link to live stream data and user location.

In certain embodiments, the method may further include recording and transmitting metadata including time stamps, biometric readings or device orientation, with the emergency data stream. In certain embodiments, the emergency data stream, may be stored and maintained for a predetermined retention period. In certain such embodiments, the collected data set may be encrypted. In certain embodiments, the method may be initiated by an application on the mobile communication device, and may continue transmitting the first video stream, the second video stream, the audio stream, and the stream of geolocation coordinates, even when the application is minimized. In certain embodiments, the method may further include recording a set of messages exchanged during the session and storing said the set of messages with timestamp metadata for post-incident review. In certain embodiments, the method may further include providing a user interface element allowing the user to share a web-accessible link to the emergency data stream with a third party not using the application.

In certain embodiments, the method may further include periodically polling device connectivity and initiating fallback SMS alerts containing location data when connectivity is interrupted. In certain embodiments the session initiation input may further include a passive physiological input such as biometric sensor data or heart rate spikes or drops detected by a connected wearable device. In certain embodiments, the method may further include initiating a delay-based alert countdown, allowing cancellation of a session within a pre-defined time window unless a session confirmation input is received. In certain embodiments the method may include further enabling the user to send a ‘nudge’ notification to specific contacts to join the emergency stream. In certain embodiments, the application may allow the user to define emergency escalation logic including time-to-escalate rules, non-response triggers, and escalation to professional monitoring services. In certain embodiments, the application allows the user to define emergency escalation logic for requesting an emergency response from local authorities. In certain embodiments, the application may be linked to a ride-hailing or transportation service platform, and a potential emergency session may automatically initiated if the user deviates from a predetermined route or cancels a destination unexpectedly.

In certain embodiments, the application comprises an interface capable of providing a visual or haptic feedback to the user confirming successful initiation of a potential emergency session and transmission of emergency data streams to the remote dispatcher or monitoring center, without exposing the activity to observers. In certain embodiments the user interface of the mobile application may have a discreet mode where it simulates a phone dialing screen or a game, such a user can use the application and receive feedback without an observer being able to see what the user is doing.

In certain embodiments, the method may further include detecting the user's movement speed and generating contextual alerts suggesting the user go live or initiate a safety broadcast when walking, driving, or entering geofenced high-risk zones. In certain such embodiments, the application may automatically prompt the user with a pre-alert notification when a vehicular or a pedestrian motion is detected exceeding a predefined threshold, offering the user one-tap access to emergency activation or live streaming. In certain embodiments, the application may employ a motion-triggered logic to initiate a passive monitoring state that escalates to full emergency activation if user interaction is not confirmed within a specified timeframe. In certain embodiments, the application may use an on-device speech-to-text model to generate a live transcript of the audio stream and transmits the transcript with the emergency data stream.

In an embodiment, a system for monitoring rider safety may include a monitoring system that may have an AI model trained to identify dangerous circumstances in video streams or audio streams, and a first client application installed on a user's mobile communication device. The first client application, upon activation of a first potential emergency session, may transmit a first emergency data stream to be accessible by the monitoring system. The first emergency data stream may include a front-facing camera video stream, a rear-facing camera video stream, an audio stream, and a geolocation data stream. The monitoring system, upon receiving an activation of a potential emergency session, may assign the potential emergency session to a first administrator, and provides the first administrator with access to the first emergency data stream.

In certain embodiments, the monitoring system comprises a configurable dashboard allowing administrators to monitor, audit, and manage potential emergency sessions across multiple users in real time. In certain embodiments, the monitoring system may provide the front-facing video stream and/or the rear facing video stream to the AI model for the identification dangerous circumstances. In certain embodiments, the monitoring system may initiate a request for emergency response with authorities local to the user's location when the AI model identifies dangerous circumstances. In certain embodiments, the monitoring may system escalates a potential emergency session for immediate attention from the first administrator with a suggestion to initiate a request for emergency response with authorities local to the user's location, when the AI model identifies dangerous circumstances from the front-facing video stream or the rear-facing video stream. In certain systems, the monitoring system may provide the audio stream to the AI model for the identification of dangerous circumstances. In certain systems, the monitoring system may initiate a request for emergency response with authorities local to the user's location when the AI model identifies dangerous circumstances from the audio stream. In certain embodiments, the monitoring system may escalate a potential emergency session for immediate attention from the first administrator with a suggestion to initiate a request for emergency response with authorities local to the user's location, when the AI model identifies dangerous circumstances.

In certain systems, the monitoring system may process the audio stream to generate a live audio transcript using a speech to text model. In certain systems, the transcript may be summarized using artificial intelligence, and may be appended to the first emergency data stream for rapid incident review. In certain embodiments, the system may further include a remote command feature allowing administrators to remotely activate or deactivate specific emergency stream features including audio, video, or location updates. In certain embodiments, the first emergency stream data may be partitioned by event segments (pre-alert, alert, escalation, resolution), with each segment timestamped and annotated.

In an embodiment, a non-transitory medium may be provided with a set of instructions that when executed by a processor, cause the processor to perform any of the methods described above.

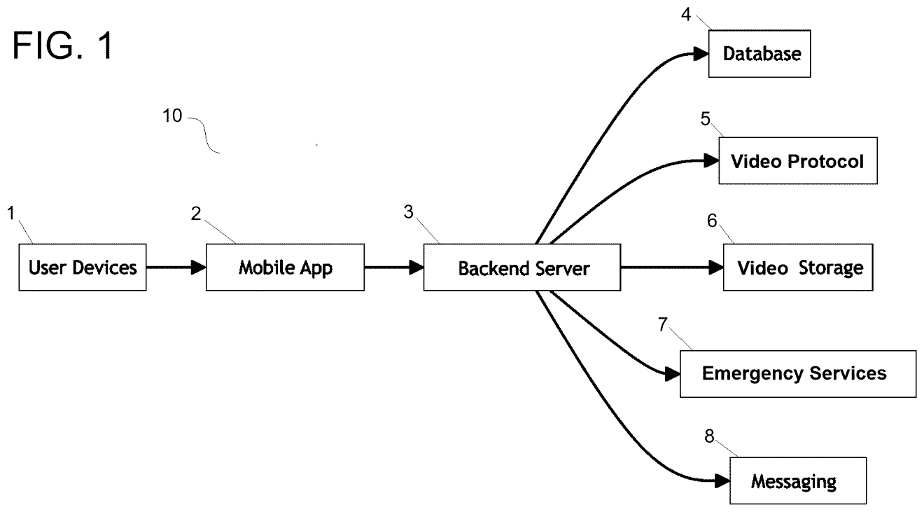

FIG. 1 illustrates a system architecture diagram for a system for social broadcasting safety 10 comprising a mobile application 2 designed to run on user device 1, and backend server 3. The user device 1 may be any suitable device, preferably having both a forward facing camera and a rearward facing camera, a microphone, and a GPS receiver. The mobile application 2, as described in greater detail below, may be capable of communicating with the backend server to initiate potential emergency sessions, escalations to an emergency response request, enable communications, facilitate simultaneous recording of video streams from both the forward-facing and rearward-facing cameras on the user device, and facilitate communication recording and transmitting video streams, an audio stream captured by the user device 1's microphone, a the user device's GPS location data in real time, for recording and/or processing by the back end server. 3

The backend server, as described in greater detail below may facilitate communication between the user and a remote dispatcher/monitoring center, requests for emergency response by authorities that are local to the user, and coordination of the delivery of the data streams recorded by the user the remote dispatcher/monitoring center, local authorities, and/or to the proper third party viewers. The backend server 3 may communicate with, or control communications with a database 4, a video protocol 5, a video storage service 6, an emergency services provider 7, and a messaging system 8 The database 4 may be any suitable database system known in the art or to be developed that may be used for storage of all relevant data received during such incidents, including, but not limited to, user information, such as name, number, description, photographs, address, etc. user preferences, such as escalation thresholds and logic, time-to-escalate rules, non-response triggers, escalation to professional monitoring services, viewer lists, timing settings, etc., session information, including the start time, all inputs received from the user, and the timing related to same, all responses and notifications sent to the user during the session, and any other information that may be useful.

The video protocol 5 may be any suitable video protocol known in the art or to be developed that can be used to record, encode, compress and transmit a live-stream video feed, including but not limited to the Agora Video SDK. The video protocol may be available to both the mobile application 2 and the backend server 3, and the backend server 3 may control pushing updates to the video protocol 5 to the mobile application 2. The video storage service 6 may be any suitable storage location known in the art or to be developed, that can store and make available both the live stream data captured during the sessions, and the complete copies of same kept after the sessions have been completed. The emergency services protocol 7 may be a remote dispatcher or monitoring service, or a protocol for communicating to same, such as the NoonLight API, or any other such protocol or system known in the art or to be developed. It may provide services for communicating with the user during potential emergency sessions, and/or during escalations to an emergency response request. The messaging system 8 may be any suitable messaging system, including but not limited to Firebase Cloud messaging, SMS messaging, and any other messaging systems known in the art or to be developed. This messaging system may be used to provide the user feedback relating to the success of certain actions, such as initiating a potential emergency session, escalating such a session to a request for emergency response, status updates regarding the stages of an emergency response, communication between the user and a remote dispatcher/monitoring center, communications between law enforcement and the user, and any other messages that may be needed.

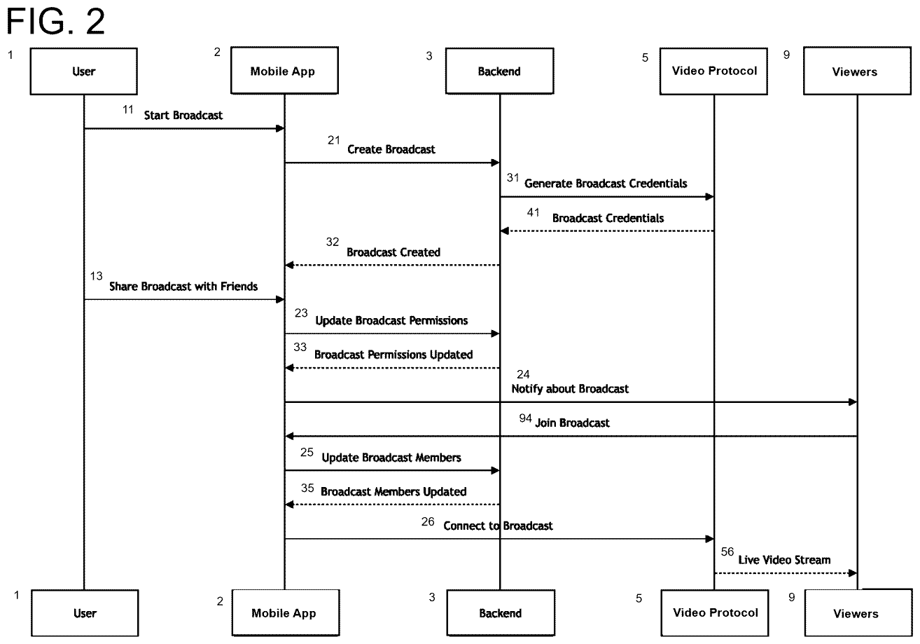

FIG. 2 illustrates is a flow diagram of user input modalities and their respective activation triggers to initiate a potential emergency session in a system 10 in accordance with the disclosed concepts. A user may use their user device 1 to initiate a request to initiate a potential emergency session and start a broadcast 11 on the mobile application 2. The request to initiate a potential emergency session/start a broadcast 11 may be made through any suitable input known in the art or to be developed, including but not limited to activation via widget taps on the mobile application 2, shake gestures employed on the user device 1, spoken safe words captured by the microphone, particular button combinations (these may be hardware, such as hitting the volume buttons in a particular sequence, or software, such as “dialing” a number on a touch screen that looks like a phone dialing screen), or peripheral device/external accessories such as wearable devices with a BlueTooth or other suitable connection to the user device that can send a signal to the application to initiate a potential emergency session/start a broadcast 11 when a button is pressed or other input is made on the wearable device. The mobile application may have a user interface that mimics the user device's normal phone screen, a texting application, another application, such as a game or video streaming application, in order to allow the user to discreetly provide activation input if they are in potentially dangerous circumstances. For example, the mobile application may provide visual or haptic feedback to the user confirming successful initiation of a potential emergency session and transmission of emergency data streams to a remote dispatcher or monitoring center, without exposing the activity to observers. Upon receiving initiating input, the mobile application 2 may create a broadcast request 21 from the backend server 3. The mobile application may further activate the user device's forward facing and rearward facing cameras, and simultaneously begin recording a video stream on each. The mobile application may further begin recording one or more audio streams using its microphones, either separately or integrating into one or both video streams, and may further begin recording user device geo-location data from the device's GPS receiver. The mobile application may periodically packetize and transmit emergency streaming data, including but not limited to the front and rear video streams, the audio stream and the stream of GPS geo-location data. Other data may be included in the emergency streaming data, including time stamps, and information about how the phone is being held, heart rate and other biometric data provided by Bluetooth devices, such as a smart watch or a heart rate monitor. Once the potential emergency session is initiated, it may be maintained by the mobile application 2 until the user enters a particular input, such as a security pin, so that other people, such as an aggressor, cannot end it. Similarly, the mobile application may continue to run in the background, even when minimized, continuing to transmit the video, audio and location data when the mobile application 2 is not visible on the user device's 1 display. The mobile application 2 may also run in a semi-minimized state, such as a picture-in-picture format, allowing the user to continue to use the application in a portion of the user device display, while the device can be used normally outside of that picture-in-picture window.

When a request to create a broadcast 21 is received by the backend server 3, It may generate a request for broadcast credentials 31 using a video protocol 5, which may provide the backend server 3 with broadcast credentials 41. Upon successfully receiving same, the backend server 3 may notify the mobile application that the broadcast has been received. The mobile application 2 may provide the emergency streaming data to the backend server 3 for distribution and processing, or it may directly provide the emergency streaming data to the video storage 6 location, where it may be accessible by the backend server 3. The backend server 3 provides the mobile application with a broadcast created notification 32 that may be communicated to the user through visual, haptic, or other suitable feedback, such as vibrations. While auditory feedback may be used with the disclosed concepts, one of the features of system 10 is that it can be implemented to work completely silently and discreetly. Audio feedback may be heard and recognized by a belligerent causing dangerous circumstances, but haptic and visual feedback can be designed to mimic the ordinary usage of the user device, such as receiving normal text messages or application notifications. The backend server 3 may further provide processing on the emergency streaming data. For example, it may monitor and use voice recognition software to detect additional key words in the audio stream, which can be used for escalating a potential emergency session into an emergency response request, or for deescalating or deactivating such a request or session. Additionally, the backend server, or a separate processing module or resource, may be provided with an AI model trained on processing emergency streaming data, and to recognize dangerous circumstances from either video stream, or from the audio stream, or from a combination of both. Such an AI model could be trained from a database of past incidents where video or audio feeds are available. Any suitable method of training such an AI model, and any suitable AI model known in the art or to be developed may be used

A user may further initiate an input to share the broadcast with friends 13 on the application. In doing so, they may select the friends with which to share the broadcast, or they may have a pre-selected set of friends identified in their user preferences on the mobile application 2. Upon a request to share the broadcast with friends 13, the mobile application 2 passes the request along to the backend server, along with any updated broadcast permissions 23 provided with a request, such as a user list of friends to receive the broadcast notification. Accordingly, the mobile application 2 may allow the user to send a ‘nudge’ notification to specific contacts to encourage them to join the emergency stream. The backend server 3 may then communicate a broadcast permission updated 33 success message to the mobile application 2, which may notify the user of same through visual, haptic, or other feedback. The backend server may further generate notifications to inform the desired viewers 9 of the broadcast of the user's emergency stream. This may include sending a mobile application 2 message notifying the viewer about the broadcast 24, or it may involve sending an SMS message to the viewer with a link to open the user's broadcast emergency data streams either with the mobile application 2 or via a website. Regardless of how the notification is made, the viewer 9 may join the broadcast 94, by following the link to the mobile application 2 or website where the stream is made available. The mobile application 2 may provide the back end server with an update broadcast members notification 25 indicating that the viewer 9 has commenced watching the user's broadcast. The backend server may then provide the viewer 9's mobile application 2 with a broadcast members updated notification 35 indicating that they have successfully joined the broadcast, and then connect the viewer 9 to the broadcast 26 using the video protocol 5, which may accessing the stream from the video storage 6 or a mirror for same which will provide the live video stream 56 to the viewers 9. The mobile application 2 may allow the viewers to communicate with the user via the messaging system 8, or the viewers 9 may reach out to the user via phone or text communications.

The mobile application 2 may be implemented to poll device connectivity, checking to see whether the user device it has sufficient connection and bandwidth to communicate with the back end server and transmit the emergency data streams. If bandwidth or connectivity becomes an issue, the mobile application may adjust the encoding of the video and audio streams to require less data (or use more data when bandwidth is not at issue), and may further initiate fallback SMS messaging when connectivity is interrupted. The SMS messages may continue to contain location data, and may be used to communicate between the mobile application 2 and the backend server 3, as well as to allow the user to communicate with the emergency services protocol 7 or local dispatch 75.

The mobile application may allow the user to set a variety of user preferences that govern how the application works and who gets notified of potential emergency sessions and requests for emergency response. Such user preferences may include, without limitation, the following: lists of contacts to be notified when a potential emergency session is initiated an the manner of notification to be sent to those contacts (“nudge” notifications, alarms, in-app messages, SMS notifications, etc.); lists of contacts to be notified when an emergency response request is made, and the manner of notification; escalation thresholds and logic such as whether the user should initiate escalations or if escalations should be initiated if the user stops responding or using the mobile application, the frequency with which the mobile application should present response check prompts, time-to-escalate rules setting the timing for escalation due to non-responsiveness or based on user input (for example the user may set an emergency response to require two button presses within a one second window, non-response triggers (such as how many missed status checks should be allowed before escalating to an emergency response request, and the timing between such checks after a failed response), and preferences on the circumstances for escalation to professional monitoring services and what services should be notified.

The mobile application 2 may be linked to a ride-hailing or transportation service platform, such as Uber, Lyft, or a taxi company, or similar services. The mobile application 2 or the backend server 3 may be implemented to initiate potential emergency session automatically if the user deviates from a predetermined route or cancels a destination unexpectedly. In such circumstances the mobile application may prompt the user with a status check, and may initiate the session if the user does not respond. The backend server 3 may also initiate a session using the driver's mobile application 2 on the driver's mobile device 3. Importantly, this system can also be used to increase driver safety from unruly passengers.

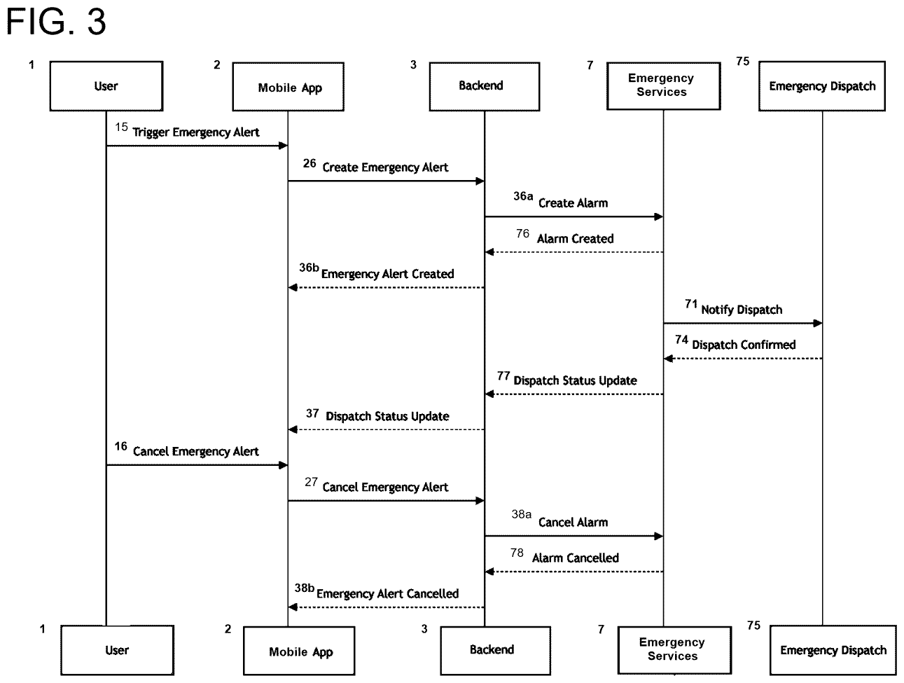

FIG. 3 illustrates flow diagram for communication between the user and a remote dispatcher, for emergency escalation using the system 10. A user may use their user device 1 to trigger an emergency alert 15. Triggering an emergency alert 15 may happen in a variety of ways. The user may manually trigger the emergency alert 15 by hitting a widget or a button on the application. Alternatively, the user may say a safe word set to trigger the emergency alert 15. The user may make a gesture with the user device 1, or hit a button or other input on a wearable device that is in BlueTooth, or other communication with the user device 1. Other methods of triggering an emergency alert may not require the user's input. For example, an AI model, as described above may be trained to detect dangerous circumstances from a video or audio feed, and may be monitoring a live stream broadcast either on the backend server 3 or on the user's device 1 via the mobile application 2. The mobile application 2 may be set to monitor a biometric reading, such as the user's heart rate, and may automatically trigger an emergency response rate if the heart rate spikes, drops below a threshold, or displays an irregular rhythm. Importantly, such triggers may occur even when a potential emergency session is not active and may lead to activation of both a potential emergency session and a request for emergency response at the same time. However triggered, the mobile application 2 may create an emergency alert 26, requesting an emergency response from local authorities. The backend server 3, upon receiving same, may create an alarm 36a and communicate the alarm to an emergency services service or protocol, such as a remote dispatcher or monitoring service, or using a protocol like the NoonLight API. The alarm may be passed along to an administrator at the remote dispatcher/monitoring service, who may locate the appropriate authorities and make an emergency response request to them. Alternatively this may be handled automatically and programmatically, and the emergency services protocol 7 may directly notify dispatch 71 by sending a notification and the relevant evidence, which may include the emergency data stream, and any collected metadata, a transcript of the audio stream prepared via a text-to-speech program, and/or a summary of same generated by a trained large language model AI. The emergency services protocol or service 7 may confirm that an alarm has been created 76 to the backend server 3, which in turn ay notify the mobile application 2 that the emergency alert has been created 36b, which may then provide feedback to the user's device via visual, haptic or other suitable feedback. The emergency dispatch service may communicate via the emergency services protocol 7 or may directly communicate with the user via the messaging system 8, an may provide a dispatch confirmed message 74 and/or periodic updates on the status of the emergency response. Dispatch status updates 77 may be provided by the emergency services protocol 7 to the backend server 3, which may then provide a dispatch status update 37 to the mobile application, which may provide visual, haptic, or other suitable feedback to the user's device 1. The create an alarm notification 36a, may also be passed along to selected viewers 9 to notify them of the situation an give them access to the emergency data streams. Their mobile application may receive such a notification and issue a high-priority sound notification using a mobile device's critical alert entitlement framework that bypasses device mute and do-not-disturb states. This alarm notification may include a link to live stream data and user location.

The user may also cancel an emergency alert if they feel the danger has passed, by touching a widget on the screen of the user's user device, saying a keyword/safe word, or through any other suitable method known in the art or to be developed. The mobile application 2 then generates a cancel emergency alert 27 which is sent to the backend server 3. The backend server may then issue a cancel alarm 38a for the emergency services protocol or service 7, which may then notify dispatch 71 that the alarm has been cancelled. Emergency dispatch 75 may then take steps to cancel the emergency response, and issue a dispatch confirm 74, to the emergency services protocol or service 7, which may confirm with an alarm cancelled notification 78 to the backend server 3. The backend server 3 may then issue an emergency alert cancelled notification 38b to the mobile application 2, which can notify the user via visual, haptic, or other suitable feedback.

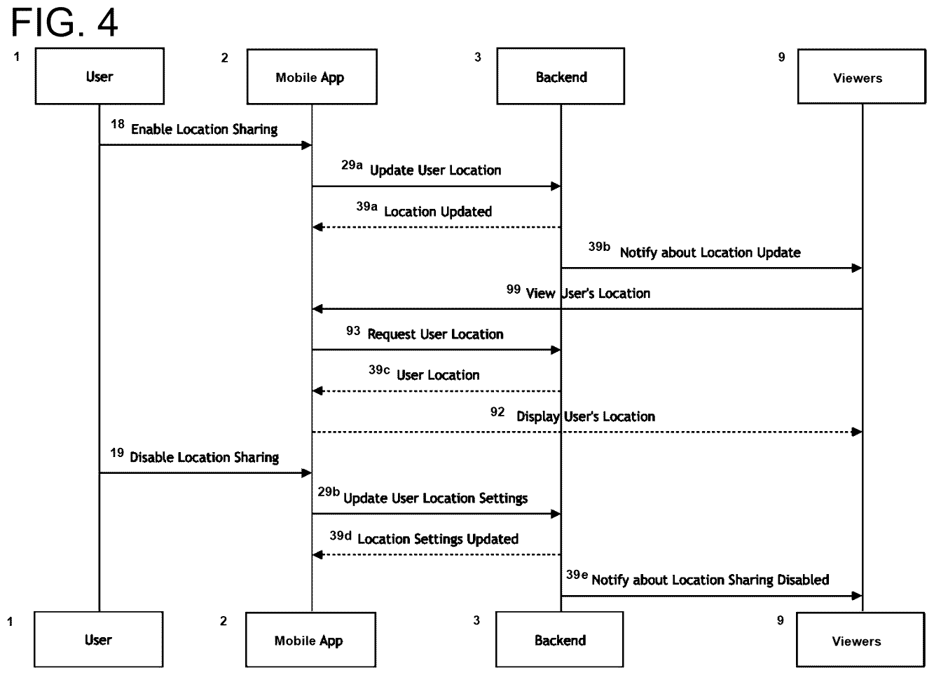

FIG. 4 is a flow diagram showing the broadcasting of the live streamed location information to viewers 9 by the system 10. The location sharing may be used as part of the potential emergency session and/or emergency response methods, described above, or it could be used independently of same. A user may enable location sharing 18 through any of input methods discussed herein, including tapping a widget on the mobile application, using a key word that is detected through a speech to text feature in the application 2, making specific gestures with the user device 1, or hitting a button or other input on a wearable BlueTooth or other wireless device. When location sharing is enabled the mobile application 2 may periodically update the user's location 29a with the backend server 3. The backend server, in turn, may confirm that the location is updated 39a, and may further notify selected viewers 9 about the location update 39b. The location update notification 39b may be through the mobile application 2 on the user's device 1, or may be through SMS or another suitable communication methodology. The viewers 9 may use the mobile application 2 on their user device 1, or may be directed to a website where they can generate a view the user's location 99 request, which may cause their mobile application to request the user's location 93 from the backend server 3 which may then send the user's location 39c to the viewer's 9 mobile application 2, which can then display the user's location 92 by displaying a map with the location highlighted, or through any other methodology for same known in the art or to be developed.

Similarly, a user may disable location sharing 19 by providing input to the mobile application using any of the input methodologies discussed above. This may be done globally for all viewers 9, or on a viewer 9 by viewer 9 basis. The mobile application 2, may generate an update user location settings notification 29b for the backend server instructing the backend to cease further communications relating to the user's location, The backend may confirm the location settings as updated 39d, and may further notify any affected viewers that the user has ceased location sharing 39c.

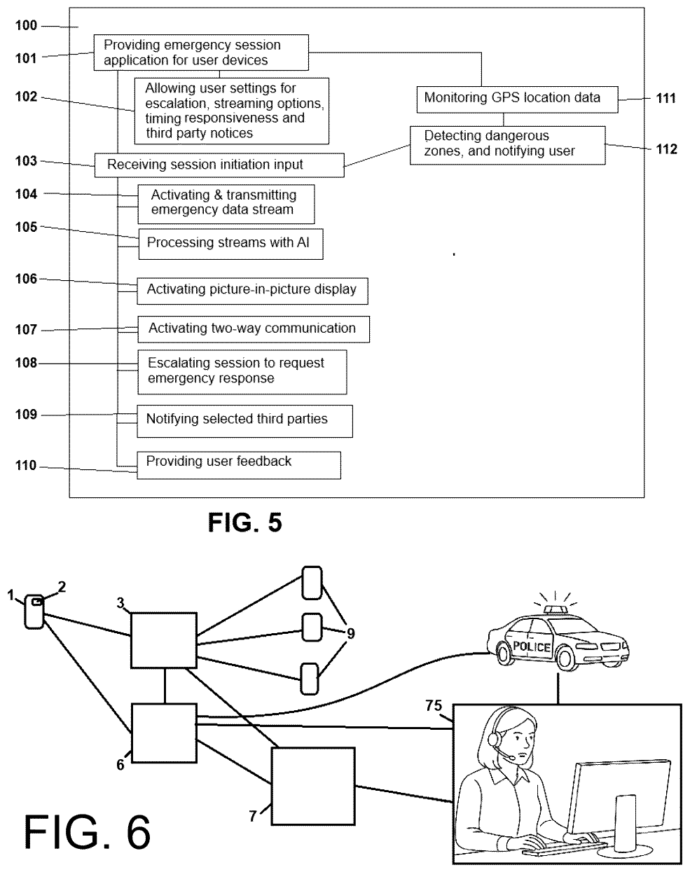

FIG. 5 illustrates a flow diagram for a method for discreetly improving a user's safety 100. The method may include providing an application that allows initiation of potential emergency sessions 101, that can receive session initiation input 103, and may include a passive monitoring feature 111. The application may allow the user a variety of user settings 102, which can allow the user to set circumstances for escalation of a potential emergency session into a request for emergency services, including but not limited to the user's failure to respond to certain prompts, the use of a panic button on the graphical user interface, the use of certain motions or gestures or facial expressions using the rear-facing camera on the mobile device. Other settings may include streaming options, such as what data should be streamed, and whether off-plan data transmission options should used, and when they should be used, the timing settings for when the user should be expected to respond to a prompt, or confirm the initiation of a session, or the like, and the identification of third parties who should receive notices when a potential emergency session or emergency response request is initiated and which data streams those third parties should be given access to.

When the application receives session initiation input 103, it may activate and transit emergency data streams, including but not limited to a first front-facing camera video stream, a second rear-facing camera video stream, an audio stream of environmental audio captured by the mobile device's microphone, and GPS location data from the mobile device's GPS receiver. Other data, such as transcription of the audio via text-to-speech or meta data about time stamps, biometric data (such as heart rate), or device orientation may also be included. The application may also initiate AI review of the emergency data streams on an on-device or remote dispatcher/monitoring center AI model trained to process audio and/or video streams to identify dangerous circumstances. When the AI detects dangerous circumstances it may directly initiate an emergency response from authorities local to the user's location, or it may escalate the potential emergency session to a human for review and authorization of an emergency response request from local authorities.

During a potential emergency session, the device may display application in a semi-minimized picture-in-picture format 106. This may allow for the user to continue to use the phone normally, while also being able to receive notifications and use the mobile application 2. The mobile application would function normally in the smaller window that it is given, and the phone would operate normally when the user manipulates it outside of the application's window. During a potential emergency session, the application may activate two-way communication between the user and the remote dispatcher/monitoring center. During a potential emergency session, the application may provide an interface option to escalate the potential emergency session into a request for emergency response 108 from local authorities. It may do so in response to key words detected in the audio stream, specific gestures with the mobile device, or by the user hitting a panic button.

During a potential emergency session, or when the session is escalated to a request for emergency response, the application may initiate notifications to selected third parties 109, pursuant to the users settings. During a potential emergency session, the application may further provide feedback to the user 110 in the form of a visual cue or haptic feedback to indicate that the potential emergency session has successfully been initiated, to confirm that the data streams are successfully being transmitted, and/or to confirm that a request for emergency response has been successfully initiated.

Passive GPS monitoring 111 may optionally be engaged to detect when the user may be in danger and should consider preemptively activating a potential emergency session. For example, the application may prompt the user when the user enters a GPS neighborhood or zone 112, or the settings may allow the application to automatically initiate a potential emergency session. Such areas may be identified by the user, or by the remote dispatcher/monitoring station, which may set up geo-fenced zones known to be dangerous, and where extra caution should be used. The mobile application 2 may automatically also prompt the user with a pre-alert notification when a vehicular or a pedestrian motion is detected exceeding a predefined threshold, offering the user one-tap access to emergency activation or live streaming, or automatically beginning the session if the user fails to respond, or if other conditions are met (the unusual speed continues for a predefined time, a safe word is detected, etc.)

FIG. 6 illustrates a system for rider safety 10. The system 10 may include a user device 1 on which a mobile application 2 is installed, a backend server 3/monitoring station, a video storage service 6, an emergency services protocol service 7, a local dispatcher 75 and first responders. The mobile application in FIG. 6 is shown in picture-in-picture mode, occupying only a portion of the user device's 1 display, allowing the user device to function normally around the mobile application frame, while allowing the user to use the mobile application and receive notifications on it. The mobile application 2, or client application, allows the user to initiate potential emergency sessions, escalate those into requests for emergency response, transmit emergency streaming data, including video from the front-facing camera, rear-facing camera, an audio stream of audio picked up by the user device's 1 microphone, and a geo-location data stream from the user device's GPS receiver, set user preferences, and perform any of the methods discussed above in greater detail for the mobile application 2. The backend server may act as a monitoring station and may coordinate communication between the mobile application 2, the video storage system 6 and the emergency services protocol service 7, as described above. It may also manage communication to mobile applications on viewer devices 2 and/or provide links to viewer devices through SMS, email or other communication methods to provide them with access to the live streaming data from the user device's 1 mobile application 2 during a potential emergency session and/or during escalation to an emergency response request. It may also perform any of the methods disclosed above for the backend server 3. The video storage service 6 may store and make available for distribution the live stream data, and may store a copy of the full stream once the live stream has finished. The emergency services protocol service 7 may provide an administrator to communicate and monitor the user's situation, handle requests for escalating into a request for emergency response from local authorities, and handle the actual communications to the local authority emergency dispatch 75. Persons of skill in the art will recognize that the disclosed concepts can be implemented in a myriad of ways, and some of these systems may be combined or systems may be separated into separate modules to accomplish the goals of the disclosed concepts within the contemplated scope of same.

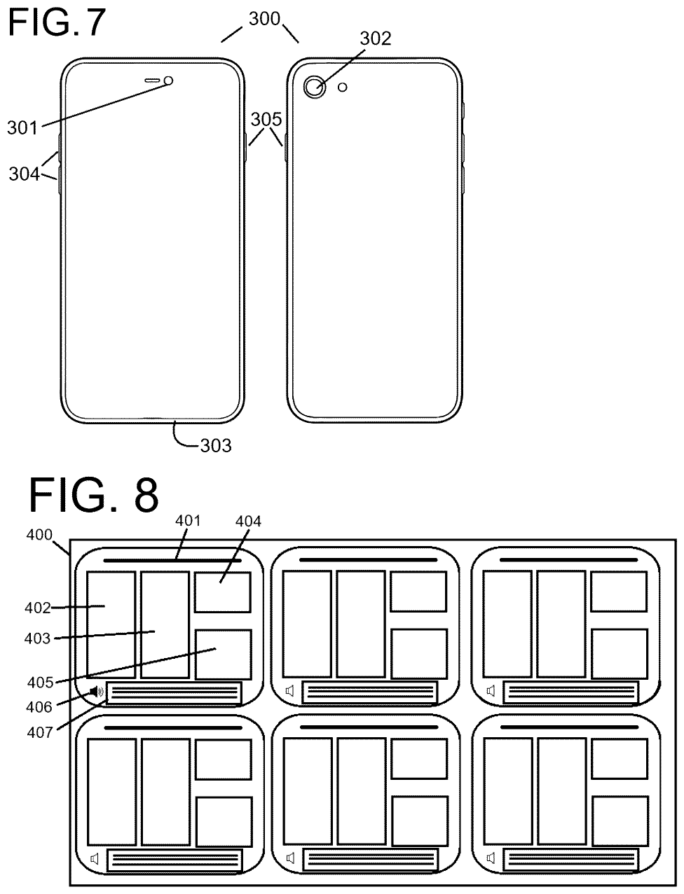

FIG. 7 illustrates a user device 1, 300 that may be used with the systems and methods discussed above. The user device may have a forward facing camera 301, a rear-facing camera 303, one or more microphones 303, hardware buttons, like the volume buttons 304, and a power button 305. It may have a GPS receiver, and hardware and software that allow it to run applications, such as the mobile application 2 described above, and communicate with other computers, such as the backend server 3, via the Internet or a VPN. It may further be provided with BlueTooth and other wireless communications protocols to allow it to connect to external accessories/peripheral devices, such as heart rate monitors, smart watches, emergency buttons, and other such devices, all of which can then be used in accordance with the methods and systems described above.

FIG. 8 illustrates a monitoring system dashboard user interface 400. The dashboard may include a plurality of potential emergency sessions 401. Each may include identifying information 402, a first video stream 403, a second video stream 404, an additional information window 405, a sound control 406 and a message history 407. The identifying information may include the user's name and/or ID number, or any other suitable identifier. The first video stream 403 and second video stream 404 may be the video streams provided by the user device 1, and may be received directly from the user device 1 or from a video storage server 6. The administrator may be able to pause or enable the video for multiple sessions at once. The sound control 406 may allow an administrator to listen to the sounds from a particular session, automatically muting all other sessions. The additional information window 405 may include other information about the user and metadata collected, such as their address, phone number, contact list (i.e. viewers 9 who should be notified), biometric readings, if available, etc. A message window 407 may track all messages exchanged with a user. And may also include a live text feed of the audio stream generated by an AI model or text-to-speech program processing the audio stream.

A proprietary dispatcher interface allows two-way text communication, PIN-based event deactivation, and access to archived stream data. The emergency stream operates in picture-in-picture (PIP) mode, allowing users to multitask while remaining under monitoring. Artificial intelligence-based threat detection may autonomously initiate the emergency state when visual indicators of violence or weaponry are detected.

The backend architecture may include a Node.js server, MongoDB database, AWS S3 media storage, Firebase Cloud Messaging for push alerts, Agora SDK for video transport, and the Noonlight API for emergency responder dispatch. Recordings may be encrypted and retained for a minimum of ninety (90) days to support review or forensic use.

The emergency system may include the following elements:
1. Triggering Mechanisms: Activation via widget taps, shake gestures, safewords, button combinations, or external accessories.
2. Livestreaming: Dual-camera operation capturing user-facing and world-facing perspectives with environmental audio.
3. Geolocation Tracking: Periodic and continuous transmission of location coordinates.
4. Dispatcher Interface: Real-time access to streams, two-way messaging, emergency logging, and user PIN verification.
5. Artificial Intelligence Threat Detection: Mobile-embedded inference engines detect aggressive behavior, firearms, or blades.
6. Cloud Architecture: MongoDB for data, AWS S3 for media, Agora for streaming, and Firebase for messaging.
7. Security Layer: TLS 1.2+encryption, secure token-based authentication, and user-controlled stream deactivation via PIN.
8. Fail-Safe Modes: SMS fallbacks, Wi-Fi triangulation, offline video caching, and reconnection syncing.

The system supports flexible configuration across subscription tiers (basic, enhanced, pro, enterprise) and accommodates different use cases including rideshare trips, campus security, eldercare, domestic violence intervention, and solo travel.

The advantages of systems using the disclosed concepts are as follows:
Enables discreet activation in high-risk scenarios through multiple input methods—voice, gesture, widgets, hardware buttons—ensuring user safety even when speech or overt movement may escalate danger.
Supports dual-camera, real-time visual/audio transmission from both front- and rear-facing lenses, providing dispatchers with a complete situational view for accurate decision-making.
Seamlessly integrates with third-party dispatch platforms such as Noonlight, leveraging pre-existing infrastructure for scalability, legal compliance, and resource coordination.
Delivers AI-based automated activation with on-device inference engines trained on visual indicators of violence, enabling passive protection when a user is incapacitated or unaware.
Offers background and Picture-in-Picture (PIP) streaming modes, allowing users to minimize or exit the app without interrupting the emergency broadcast, preserving both discretion and connectivity.
Sends high-priority sound alerts using native Critical Alerts frameworks that override device mute and Do Not Disturb settings, instantly notifying emergency contacts with location and video access links.
Ensures data continuity through robust fail-safes, including fallback to SMS-based location alerts, offline video caching, auto-resume streaming on reconnection, and Wi-Fi/cell-tower triangulation for location estimation.
Enables cloud-based evidence archiving via MongoDB and AWS S3, retaining timestamped video, audio, messaging, and location metadata for at least 90 days to support post-incident analysis or legal proceedings.
Supports diverse use cases: rideshare safety, university and campus security, eldercare monitoring, domestic violence response, and remote or solo travel safety—making it highly adaptable across industries.
Designed with accessibility and equity in mind, offering voice-guided onboarding, scalable UI for seniors or visually impaired users, and preset contact templates for simplified emergency configuration.
Provides modularity through tiered feature plans (e.g., Basic, Enhanced, Pro, Enterprise), allowing customized feature access based on user needs or institutional deployments.
Offers interoperability with wearables and smart accessories, enabling Bluetooth-based emergency activation via smartwatches, lanyards, or health-monitoring devices through multiple input methods, including voice, motion, and hardware, reducing user burden in dangerous conditions.
Supports dual-camera, real-time visual/audio transmission, giving responders full environmental context and improving response accuracy.
Seamlessly integrates with emergency dispatch systems and third-party platforms such as Noonlight, expanding the system's reach and interoperability.
Offers AI-based automated activation with on-device inference for real-time threat detection, even when the user is unable to act.
Operates in background/Picture-in-Picture (PIP) mode, allowing the user to multitask or conceal their actions, increasing user safety in escalating scenarios.
Delivers high-priority, device-override alerts using OS-native Critical Alerts frameworks to notify emergency contacts instantly, even during silent or “Do Not Disturb” modes.
Includes robust fail-safes such as offline caching, fallback SMS, and reconnect logic to ensure continuity despite poor connectivity.
Facilitates post-event review through secure, encrypted cloud archival of all emergency session data, supporting legal, insurance, or investigative use cases.
Adapts to multiple use cases—rideshare, campus safety, domestic violence, eldercare—offering wide commercial and social impact.
Designed with accessibility in mind, offering UI flexibility for elderly or mobility-impaired users, voice-guided interaction, and customizable onboarding.
Supports dual-camera, real-time visual/audio transmission
Integrates seamlessly with emergency dispatch systems
Offers AI-based automated activation with on-device inference
Operates in background/PIP mode, increasing stealth
Includes robust fail-safes for connectivity and user error
Facilitates post-event review through secure data archival

The present invention introduces a transformative system for real-time emergency response that integrates user discretion, intelligent automation, and seamless communication. By combining dual-camera live streaming, continuous location tracking, and real-time audio capture within a secure, cloud-enabled ecosystem, the invention empowers users to request and receive assistance without escalating danger or requiring active verbalization.

The incorporation of AI-based threat detection, critical alert delivery through operating system entitlements, and persistent Picture-in-Picture streaming ensures both active and passive scenarios are accounted for, safeguarding users even when they are unable to interact with their devices. Furthermore, the layered architecture—leveraging third-party dispatch APIs, mobile SDKs, encrypted databases, and offline fail-safes—makes the system scalable, reliable, and resilient.

Through flexible configuration options, accessible design for all user demographics, and applicability across diverse real-world environments including rideshare, campus safety, eldercare, and solo travel, the invention stands as a comprehensive personal security solution. It is technologically robust, commercially viable, and positioned to redefine modern mobile safety standards through patent-protected innovation in emergency communication—discreet, autonomous, and context-rich. It is technically sophisticated yet user-accessible, enabling continuous monitoring and immediate response in life-threatening scenarios without requiring user verbalization or manual intervention.

While the invention has been described with reference to specific embodiments and examples, it will be understood by those skilled in the art that various changes may be made and equivalents may be substituted without departing from the scope of the invention. In addition, many modifications may be made to adapt a particular situation, material, composition of matter, method, or process step to the objective, spirit, and scope of the present invention. All such modifications are intended to be within the scope of the claims appended hereto.

We claim:

1. A method for initiating a discreet emergency response for a user of a mobile communication device having a front-facing camera and a rear-facing camera, a microphone, and a GPS receiver, the method comprising:
providing an application on the device capable of receiving a session initiation input, and responsive to the session initiation input, activating a potential emergency session with a remote dispatcher or monitoring center, comprising transmitting an emergency data stream to be accessible to the remote dispatcher or monitoring center, the emergency data stream comprising:
a first video stream for video images recorded by the front-facing camera of the mobile communication device,
a second video stream for video images recorded by the rear-facing cameras of the mobile communication device,
an audio stream recording of environment audio stream recorded by the microphone of the mobile communication device;
a stream of geolocation coordinates from the GPS receiver.

2. The method of claim 1 further comprising displaying the first video stream and second video stream in picture-in-picture mode on the mobile communication device.

3. The method of claim 1 further comprising maintaining the activated potential emergency session until a secure PIN is entered to terminate the potential emergency session.

4. The method of claim 1 wherein the session initiating input is selected from the group consisting of a widget tap, detecting a safe word, a motion gesture, a hardware button sequence, and a peripheral device.

5. The method of claim 6, further comprising automatically initiating the emergency response request responsive to AI-based detection of visual threat cues detected from the first video stream or the second video stream.

6. The method of claim 1, further comprising recording and transmitting metadata including time, biometric readings, or device orientation, with the emergency data stream.

7. The method of claim 1 wherein the method is initiated by an application on the mobile communication device, and continues transmitting the first video stream, the second video stream, the audio stream, and the stream of geolocation coordinates, even when the application is minimized.

8. The method of claim 1, further comprising transmitting a high-priority sound notification using a mobile device's critical alert entitlement framework to designated emergency contacts upon triggering an emergency response, wherein the alert bypasses device mute and do-not-disturb states and includes a link to live stream data and user location.

9. The method of claim 3, further comprising recording a set of messages exchanged during the session and storing said the set of messages with timestamp metadata for post-incident review.

10. The method of claim 1, further comprising providing a user interface element allowing the user to share a web-accessible link to the emergency data stream with a third party not using the application.

11. The method of claim 1, further enabling the user to send a ‘nudge’ notification to specific contacts to join the emergency stream.

12. The system of claim 1, wherein the application allows the user to define emergency escalation logic including time-to-escalate rules, non-response triggers, and escalation to professional monitoring services.

13. The method of claim 1, wherein the application is linked to a ride-hailing or transportation service platform, and a potential emergency session is automatically initiated if the user deviates from a predetermined route or cancels a destination unexpectedly.

14. The method of claim 1, wherein the application comprises an interface capable of providing a visual or haptic feedback to the user confirming successful initiation of a potential emergency session and transmission of emergency data streams to the remote dispatcher or monitoring center, without exposing the activity to observers.

15. The method of claim 1, further comprising detecting the user's movement speed and generating contextual alerts suggesting the user go live or initiate a safety broadcast when walking, driving, or entering geofenced high-risk zones; wherein the application automatically prompts the user with a pre-alert notification when a vehicular or a pedestrian motion is detected exceeding a predefined threshold, offering the user one-tap access to emergency activation or live streaming.

16. A system for monitoring rider safety comprising:
a monitoring system, comprising an AI model trained to identify dangerous circumstances in video streams or audio streams;
a first client application installed on a user's mobile communication device, wherein the first client application, upon activation of a first potential emergency session, transmits a first emergency data stream to be accessible by the monitoring system, wherein the first emergency data stream comprises a front-facing camera video stream, a rear-facing camera video stream, an audio stream, and a geolocation data stream;
wherein the monitoring system, upon receiving an activation of a potential emergency session, assigns the potential emergency session to a first administrator, and provides the first administrator with access to the first emergency data stream.

17. The system of claim 16, wherein the monitoring system provides the front-facing video stream, the rear facing video stream or the audio stream to the AI model for the identification dangerous circumstances.

18. The system of claim 17 wherein the monitoring system escalates a potential emergency session for immediate attention from the first administrator with a suggestion to initiate a request for emergency response with authorities local to the user's location, when the AI model identifies dangerous circumstances from the front-facing video stream or the rear-facing video stream.

19. The system of claim 16, wherein the monitoring system provides the audio stream to the AI model for the identification of dangerous circumstances; and wherein the monitoring system initiates a request for emergency response with authorities local to the user's location when the AI model identifies dangerous circumstances from the audio stream.

20. The system of claim 16 wherein the monitoring system process the audio stream to generate a live audio transcript using a speech to text model, wherein the transcript is summarized using artificial intelligence, and appended to the first emergency data stream for rapid incident review.
